(19) United States
(12) Patent Application Publication
(10) Pub. No.: US 2024/0219075 A1
(43) Pub. Date: Jul. 4, 2024

(54) INFLATABLE NON-IMAGING SOLAR CONCENTRATOR POWERED HIGH TEMPERATURE THERMO-CHEMICAL REACTION SYSTEM

(71) Applicant: Yonghua Wang, Klamath Falls, OR (US)

(72) Inventor: Yonghua Wang, Klamath Falls, OR (US)

(21) Appl. No.: 17/803,855

(22) Filed: Dec. 30, 2022

(51) Int. Cl. F24S 20/80; F24S 23/30; F24S 23/71; F24S 60/20; F24S 80/50; F24S 80/70

(52) U.S. Cl. CPC F24S 20/80; F24S 23/31; F24S 23/71; F24S 60/20; F24S 80/50; F24S 80/70

(57) ABSTRACT

An inflatable non-imaging solar concentrator powered high temperature thermo-chemical reaction system, which is designed to reduce CO2 into CO and H2O into H2 for liquid fuels such as methanol and kerosene, comprises: 1) an inflatable non-imaging solar concentrator with a transparent cover and a Compound Parabolic Concentrator (CPC); 2) the first stage of the multi-stage non-imaging non-tracking solar concentrator with a domed divergent Fresnel Lens transparent cover and a CPC; 3) the second stage of the multi-stage non-imaging non-tracking solar concentrator with a domed divergent Fresnel Lens transparent cover and a CPC; 4) a high temperature thermo-chemical reactor with a steel high pressure vessel, an insulation layer, a first CeO2 catalyst layer, and a second CeO2 catalyst layer.

### TECHNICAL FIELD

The present disclosure relates generally to concentrating solar powered thermo-chemical reaction system, more specifically, to inflatable non-imaging concentrator powered high temperature thermo-chemical reaction system.

### BACKGROUND

Fast progress of technologies advances the wide-spread adoption of solar energy. The fossil fuel depletion and global warming are consistently promoting the alternation of fossil to renewable energy. However, up to present, the total contribution of solar energy to power supply of society is still less than 5% averagely over the world. Solar energy research and application are facing 4 grand challenges: 1) the low conversion efficiency of solar technologies; 2) the high cost of solar systems; 3) the intermittence of solar energy resources; 4) the stubborn difficulty in aviation electrification. Comparing with all other energy storage mediums, the natural fossil fuels are approved the best medium of energy storage, in terms of gravity and energy density. Therefore, E-fuel such as the one synthesized from CO2 and H2O provides one of the most desirable routes to address all of the challenges in once.

The low efficiency of solar technologies stems from the broad spectrum of solar irradiance and the fixed band gap of semiconductor used for photovoltaic conversion. During the photovoltaic conversion process with normal single junction panel, only fraction of photon energy from solar radiation is efficiently converted into electricity by typical single junction of photovoltaic cell, while the majority of the incident photon energy of solar radiation is converted into heat due to the mismatch of photon energy and band gap of semiconductor. As shown by Bube (Bube, Richard H. (1998) Photovoltaic Materials, Imperial College Press, pp 1-33), for a typical crystalline silicon solar cell, about 50% energy of incident light is lost through the spectral loss mechanism. The spectral loss mechanism is the dominated one among the other loss mechanisms and only small fraction of energy about 18% is converted into electricity while majority of energy is converted into heat. The high cost of current photovoltaic technologies is due to the low energy current density of solar radiation that leads to the adoption of large area semiconductor panels for direct collection and conversion of solar radiation. The spinning and orbiting of earth cause sun rising and sunset that cause intermittence of solar radiation. The weather change brings in another mechanism for intermittence of solar energy resource.

Concentrating solar power generation systems including Concentrating Photovoltaic (CPV) systems and Concentrating Solar Thermal Power (CSP) systems are demonstrated promising approaches to realize high conversion efficiency and low cost. Thermo-chemical reduction of CO2 and H2O to generate CO and H2, and further synthesis of CO and H2 into liquid fuels such as methanol and kerosene at high temperature, are approved one of the most desirable pathways to address the CO2 emission issue and the sustainable fuel production issue. The combination of the concentrating solar power generation systems provides an unprecedented opportunity to use solar radiation to generate high temperature heat inside of a insulated thermo-chemical reactor to produce the mixture of CO and H2 the syngas and further synthesize it into liquid fuels. This route has a great potential in addressing the 4 grand challenges talked above in one strike.

Stefan Zoller et al (Stefan Zoller, Erik Koepf, Dustin Nizamian, Marco Stephan, Adriano Patane\acute{ }, Philipp Haueter, Manuel Romero, Jose\acute{ } Gonza\acute{ } lez-Aguilar, Dick Lieftink, Ellart de Wit, Stefan Brendelberger, Andreas Sizmann, and Aldo Steinfeld, A solar tower fuel plant for the thermochemical production of kerosene from H2O and CO2, Joule 6, 1606-1616, Jul. 20, 2022), report “A solar tower fuel plant for the thermochemical production of kerosene from H2O and CO2”. In the configuration of their system, a heliostat field is employed to concentrate sunlight with a concentration ratio 2500 suns into a reactor mounted on the top of a solar tower to activate the thermochemical reaction between H2O and CO2 at high temperature to produce aviation fuel kerosene directly. A solar-to-syngas energy conversion efficiency of 4.1% was achieved without applying heat recovery for a 50 kw cavity chamber receiver as the reactor. In their system, the photon energy of solar radiation is directly transformed into chemical energy of aviation fuel in large scale. This approach directly mitigates the 2 issues of utility scale energy storage associated with intermittence of the solar energy resource and aviation fuel supply from sustainable energy. In the photonic-thermal conversion process, the whole spectrum of the solar radiation is absorbed and converted into thermal energy. Therefore, this approach mitigates the potential energy loss due to the band gap mismatch with incident photon energy in photovoltaic conversion processes and creates an unprecedented opportunity to dramatically increase its conversion efficiency. The combination of heliostat field and high temperature chemical reactor open a new route to not only directly convert renewable energy into chemical energy and store it in a liquid medium, but also extraordinarily reduce the total cost of solar energy conversion systems. Heliostat field based solar tower power plant is demonstrated one of the cost effective configurations in concentrating solar power generation. However, the solar tower power plant is only feasible for large scale system. Small scale and more cost effective concentrating thermo-chemical solar-liquid fuel conversion system appears to be a promising research direction.

In the design paradigm of the solar tower thermo-chemical system, the sunlight is reflected upward to the receiver mounted on the top of the tower. This configuration presents some certain level difficulty in designing and installing large scale thermo-chemical reactor due to the limited space on the top of the tower and the high elevation of the tower. Therefore, downward concentration is more favorable for large scale system design with thermo-chemical reactor located on ground. Furthermore, in the solar tower system, sunlight propagates in free space; there is no control of light path. Large scale optical waveguide may provide significant convenience to the design of the thermo-chemical reaction system.

Schäppi, at al (Preprint version of the article: Schäppi, R., Rutz, D., Dähler, F., Muroyama, A., Haueter, P., Lilliestam, J., Patt, A., Furler, P., Steinfeld, A. (2022): Drop-in fuels from sunlight and air, in Nature 601, pp. 63-68. https://doi.org/10.1038/s41586-021-04174-y), reports a system that Drop-in fuels from sunlight and air. They demonstrate a system including 3 units: 1) the direct air capture (DAC) unit which co-extracts CO2 and H2O directly from ambient air; 2) the solar redox unit which converts CO2 and H2O into a desired mixture of CO and H2 (syngas); and 3) the gas-to-liquid (GTL) unit which converts syngas to liquid hydrocarbons or methanol. In their solar redox unit, a parabolic dish is employed to concentrate sunlight to the thermo-chemical reactor in a concentration ratio over 3000 suns. Parabolic dish concentrator can concentrate sunlight in high concentration ratio, but it can only concentrate Direct Normal Solar Irradiance (DNI) and requires high tracking accuracy. In the configuration of their system, the bulky thermo-chemical reactor is mounted at the focal point of the parabolic dish concentrator which blocks some incident sunlight.

U.S. Pat. No. 9,950,305 B2 granted to Robert S. Wegeng, et al (Wegeng), disclose a solar thermo-chemical processing system and method. Wegeng's system adapts a parabolic dish as solar concentrator which can only concentrate beam light.

The present invention employs the current inventor's (SolenSphere's) inflatable non-imaging solar concentrator to construct a concentrating thermo-chemical solar-fuel system with the CO2 and H2O thermo-chemical reactor located at the bottom of solar concentrator and incorporates SolenSphere's multi-stage non-imaging non-tracking solar concentrator into the reactor to realize ultra-high concentration ratio. This approach will drastically reduce the total cost of the system, substantially simply the structure of the system, and significantly increase the total efficiency of the system. This pathway directly converts CO2 and H2O into syngas. In conjunction with Fischer-Tropsch (FT) reaction, the syngas will be further synthesized into liquid fuels methanol or kerosene. Therefore, the proposed project simultaneously addresses the 4 grand challenges mentioned above by once.

### SUMMARY

According to the present invention, an inflatable non-imaging solar concentrator is deployed to concentrate sunlight downward onto a thermo-chemical reactor to realize large scale solar concentration with an extremely low cost; an multi-stage non-imaging and non-tracking solar concentrator is incorporated into the thermo-chemical reactor to further concentrate the concentrated sunlight and distribute the concentrated sunlight onto different reaction locations as an optical waveguide.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is the configuration of the inflatable non-imaging solar concentrator powered high temperature thermo-chemical reaction system including an inflatable non-imaging concentrator, a multi-stage non-imaging non-tracking concentrator, and a high temperature thermo-chemical reactor.

FIG. 2 is the top unit of the multi-stage non-imaging non-tracking concentrator.

FIG. 3 is the multi-stage non-imaging non-tracking concentrator.

FIG. 4 is an indication of the inner structure of the high temperature thermo-chemical reactor.

FIG. 5 is the section view of the high temperature thermo-chemical reactor.

FIG. 6 is an indication of work principle for non-imaging solar concentrator to concentrate both beam and diffuse sunlight.

FIG. 7 is a 3D view of the inflatable non-imaging solar concentrator.

FIG. 8 is an indication of the work principle of the non-imaging non-tracking solar concentrator.

FIG. 9 is an indication of the work principle of the non-imaging non-tracking solar concentrator that takes the oblique incident diffuse light concentrated by its previous stage non-imaging concentrator and concentrates to next stage.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

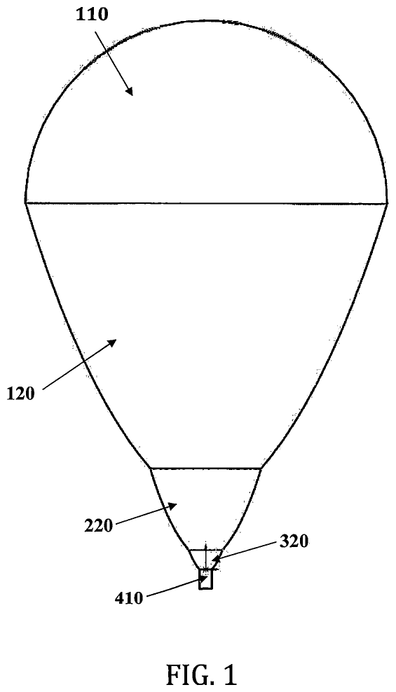

Referring to FIG. 1, the inflatable non-imaging solar concentrator powered high temperature thermo-chemical reaction system of the present invention comprises: 1) an inflatable non-imaging solar concentrator with a transparent cover 110 and a Compound Parabolic Concentrator (CPC) 120; 2) the first stage of the multi-stage non-imaging non-tracking solar concentrator with a domed divergent Fresnel Lens transparent cover 210 and a CPC 220; 3) the second stage of the multi-stage non-imaging non-tracking solar concentrator with a domed divergent Fresnel Lens transparent cover 310 and a CPC 320; 4) a high temperature thermo-chemical reactor with a steel high pressure vessel 410, an insulation layer 420, a first CeO2 catalyst layer 430, and a second CeO2 catalyst layer 440. When in operating, incident sunlight including beam light and diffuse light is firstly concentrated by the inflatable non-imaging solar concentrator 110 and 120 in a large scale and an extremely low cost, then the multi-stage non-imaging non-tracking solar concentrator including the first stage solar concentrator 210 and 220 and the second stage solar concentrator 310 and 320 further concentrate the diffuse sunlight concentrated by the inflatable non-imaging solar concentrator to reach a ultra-high concentration ratio which is normally over 1000 suns, finally the concentrated sunlight is coupled into the thermo-chemical reactor including the steel vessel 410, the insulation layer 420, the first CeO2 catalyst layer 430, and the second catalyst layer 440 to generate high temperature normally over 1000° C.

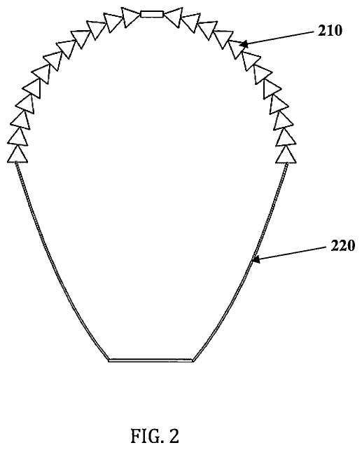

Referring to FIG. 2, the first stage non-imaging non-tracking solar concentrator comprises a domed divergent Fresnel Lens 210 and a CPC 220; the oblique incident diffuse sunlight concentrated by the previous inflatable non-imaging solar concentrator 110 and 120 is firstly diverged by the divergent Fresnel Lens 210 to reduce the incident angles relative to the CPC 220, then concentrated by the CPC 220 with large concentration ratio.

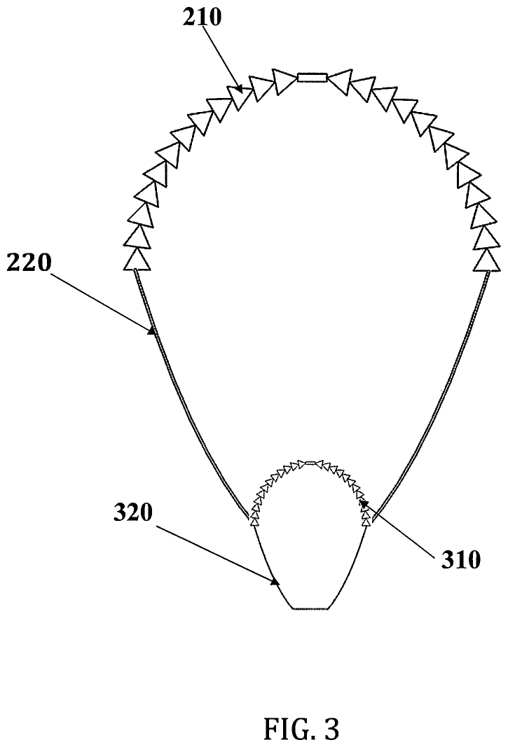

Referring to FIG. 3, two stage non-imaging non-tracking solar concentrators 210 and 220, as well as 310 and 320, are stacked together to concentrate diffuse sunlight to reach ultra-high concentration ratio.

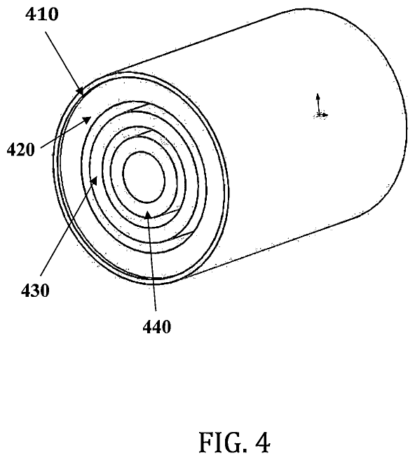

Referring to FIG. 4, the high temperature thermo-chemical reactor comprises an anti-pressure vessel 410, an insulation layer 420, a first layer of CeO2 catalyst 430, and a second layer of CeO2 catalyst 440. When in operating, H2O is fed into the gap between the insulation layer 420 and the CeO2 catalyst layer 430 to be reduced into H2; CO2 is fed into the hollow core of the CeO2 catalyst layer 440 to be reduced into CO.

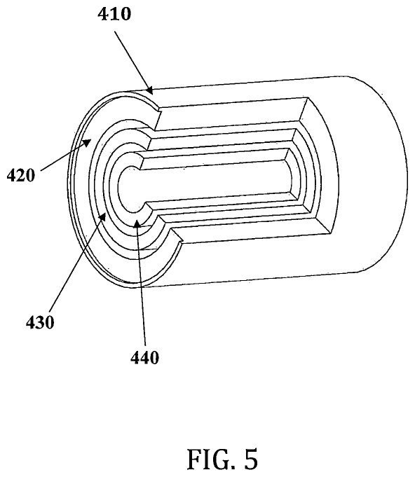

Referring to FIG. 5, the 3D cylinder structure is illustrated.

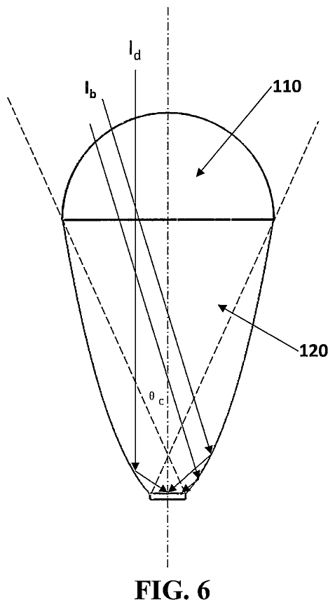

Referring to FIG. 6, the CPC is able to concentrate both the beam light I_{b} and the diffuse light I_{d}, as long as their incident angles relative to the CPC are smaller than the acceptance half-angle of the CPC.

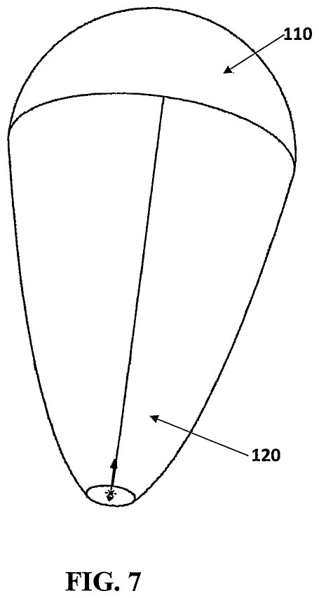

Referring to FIG. 7, the 3D view of the inflatable non-imaging solar concentrator of the present invention is illustrated.

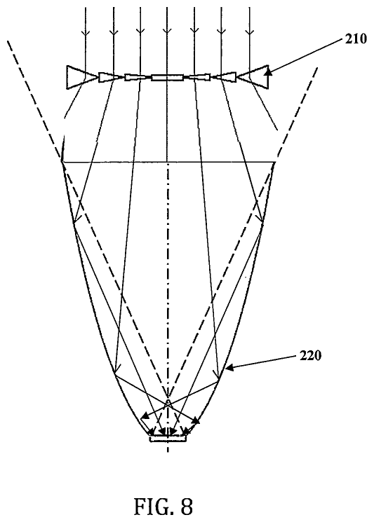

Referring to FIG. 8, the working principle of non-tracking concentrator is illustrated; incident sunlight is firstly diverged by the divergent Fresnel Lens 210 to reduce incident angle relative to the CPC 220 then concentrated by the CPC 220 with high concentration ratio.

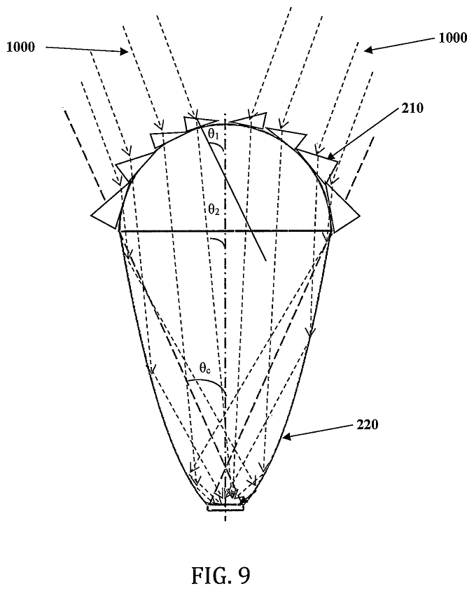

Referring to FIG. 9, in the present invention, a domed divergent Fresnel lens 210 is added on the domed transparent cover of the CPC 220 with small acceptance half-angle, so that the oblique incident light is refracted to fall in the small acceptance half-angle. In operating, the light with the original incident angle θ₁ relative to the CPC, is refracted by the left-hand side of the domed divergent Fresnel lens, and falls into the CPC with the changed incident angle θ₂, where θ₁>θ₂, θ₁>θ_{c}, θ₂<θ_{c}.

The work principle of the non-tracking concentrator structure is elucidated as the following. The concentrated sunlight from previous concentrator is refracted to change direction by various portion of the domed divergent Fresnel lens surrounding the CPC, so that the refracted sunlight falls into the relatively small acceptance half-angle of the CPC and is concentrated by it. The addition of the domed divergent Fresnel lens to the CPC enlarges the acceptance angle of the CPC, and therefore enables the concentration with high concentration ratio.

From the description above, a number of advantages of the solar concentrator become evident. The inflatable apparatus provides an approach to realize an ultra-light, exclusively cheap, extremely compact solar concentrator. The concentrator is able to concentrate both beam and diffuse light. The addition of the divergent Fresnel lens onto the domed transparent top cover of the non-imaging CPC concentrator enables the possibility to concentrate concentrated diffuse light in cascade to reach ultra-high concentration ratio. The entire system concentrates sunlight downward onto the thermo-chemical reactor so that the reactor can be located on ground to facilitate system design. Double layer CeO2 catalysts enable the separation of CO2 reduction and H2O reduction, which provides means to enhance mass transfers of reactants and products to enhance chemical reaction efficiencies.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. An inflatable non-imaging solar concentrator powered high temperature thermo-chemical reaction system comprises: 1) an inflatable non-imaging solar concentrator with a transparent cover and a Compound Parabolic Concentrator (CPC); 2) the first stage of the multi-stage non-imaging non-tracking solar concentrator with a domed divergent Fresnel Lens transparent cover and a CPC; 3) the second stage of the multi-stage non-imaging non-tracking solar concentrator with a domed divergent Fresnel Lens transparent cover and a CPC; 4) a high temperature thermo-chemical reactor with a steel high pressure vessel, an insulation layer, a first CeO2 catalyst layer, and a second CeO2 catalyst layer; wherein, the inflatable non-imaging solar concentrator with a transparent cover and a Compound Parabolic Concentrator (CPC) is positioned on the top of the system, and then the first stage of the multi-stage non-imaging non-tracking solar concentrator with a domed divergent Fresnel Lens transparent cover and a CPC and the second stage of the multi-stage non-imaging non-tracking solar concentrator with a domed divergent Fresnel Lens transparent cover and a CPC are connected into a cascaded concentrator optical waveguide to guide the concentrated sunlight onto the high temperature thermo-chemical reactor with a steel high pressure vessel, an insulation layer, a first CeO2 catalyst layer, and a second CeO2 catalyst layer; when in operating, incident sunlight including beam light and diffuse light is firstly concentrated by the inflatable non-imaging solar concentrator in a large scale and an extremely low cost, then the multi-stage non-imaging non-tracking solar concentrator including the first stage solar concentrator and the second stage solar concentrator further concentrate the diffuse sunlight concentrated by the inflatable non-imaging solar concentrator to reach a ultra-high concentration ratio which is normally over 1000 suns, finally the concentrated sunlight is coupled into the thermo-chemical reactor including the steel vessel, the insulation layer, the first CeO2 catalyst layer, and the second catalyst layer to generate high temperature normally over 1000° C.;

2. The inflatable non-imaging solar concentrator powered high temperature thermo-chemical reaction system of claim 1, wherein the inflatable non-imaging solar concentrator with a transparent cover and a Compound Parabolic Concentrator (CPC) is a closed structure with the transparent cover and the CPC sealed to form a gas bag for inflation.

3. The inflatable non-imaging solar concentrator powered high temperature thermo-chemical reaction system of claim 1, wherein the first and second non-imaging non-tracking concentrator has a domed divergent Fresnel Lens on the top of a CPC non-imaging concentrator.

4. The inflatable non-imaging solar concentrator powered high temperature thermo-chemical reaction system of claim 1, wherein the high temperature thermo-chemical reactor comprises two CeO2 catalyst cylinders which are arranged in a coaxial way with a space in between the two cylinders for feeding in H2O.
